(19) United States
(12) Patent Application Publication
(10) Pub. No.: US 2010/0056058 A1
(43) Pub. Date: Mar. 4, 2010

(54) METHOD AND APPARATUS FOR MITIGATING RADIO FREQUENCY INTERFERENCE IN A PLATFORM

(76) Inventors: Keith R. Tinsley, Beaverton, OR (US); Srikathyayani Srikanteswara, Portland, OR (US)

Correspondence Address: INTEL/BSTZ;BLAKELY SOKOLOFF TAYLOR & ZAFMAN LLP, 1279 OAKMEAD PARKWAY, SUNNYVALE, CA, 94085-4040, US

(21) Appl. No.: 12/200,769

(22) Filed: Aug. 28, 2008

(51) Int. Cl. H04B 15/00

(52) U.S. Cl. 455/63.1

(57) ABSTRACT

A method to mitigate non-Gaussian Radio Frequency Interference (RFI) in a platform. Non-gaussian RFI is sensed in the received Inphase and Quadrature (IQ) data from a radio coupled with the platform. The parameters associated with a noise model from the IQ data are determined and the platform is reconfigured based on the parameters.

### FIELD OF THE INVENTION

This invention relates to Radio Frequency Interference (RFI), and more specifically but not exclusively, to mitigate non-Gaussian RFI in a platform.

### BACKGROUND DESCRIPTION

RFI is a common phenomenon and many platforms are susceptible to narrowband or broadband RFI. RFI is termed narrowband or broadband when the interference spectrum is narrower or wider than the receiver bandwidth respectively. RFI occurs when an interfering source emits certain RF signals that propagate through a medium to cause interference to the intended operation of the platform. The RFI may interrupt, obstruct, or degrade the effective performance of the platform.

Narrowband RFI usually comes from intentional transmission such as radio, television stations, pager transmitters, cell-phones for example. Broadband RFI usually comes from incidental radio frequency emitters like shaver, computer, electric motors, power lines for example.

RFI is a combination of independent radiation events, and has predominantly has non-Gaussian statistics. However, conventional radio receivers in many wireless devices mitigate RFI based on normal or Gaussian statistics. RFI is impulsive in nature and it has a highly structured form characterized by significant probabilities of large interference levels. This is in contrast to non-impulsive Gaussian noise that has a probability density function of the normal distribution. Conventional radio receivers use correlation detectors to detect Gaussian noise but the correlation detectors are not able to detect non-Gaussian noise. Therefore, the impulsive characteristics of RFI can drastically degrade the performance of the conventional radio receivers.

### BRIEF DESCRIPTION OF THE DRAWINGS

The features and advantages of embodiments of the invention matter will become apparent from the following detailed description of the subject matter in which:

FIG. 1 illustrates an embodiment of the invention; and

FIG. 2 illustrates a flowchart of an embodiment of the invention.

### DETAILED DESCRIPTION

Reference in the specification to “one embodiment” or “an embodiment” of the invention means that a particular feature, structure or characteristic described in connection with the embodiment is included in at least one embodiment of the invention. Thus, the appearances of the phrase “in one embodiment” appearing in various places throughout the specification are not necessarily all referring to the same embodiment.

Embodiments of the invention model the true characteristics of the RFI to mitigate the effects of the RFI in the platform. A platform includes but is not limited to, a wireless device, or any system or device that has a radio transceiver. A wireless device includes, but is not limited to, a laptop with a wireless RF transceiver, a mobile phone, a radio system, or any system that includes a radio. The radio operates in accordance with, but is not limited to, Bluetooth, Institute of Electrical and Electronics Engineers (IEEE) wireless standard protocol family such as Wireless Fidelity (Wi-Fi), Ultra Wide Band (UWB), or other wireless communication protocol.

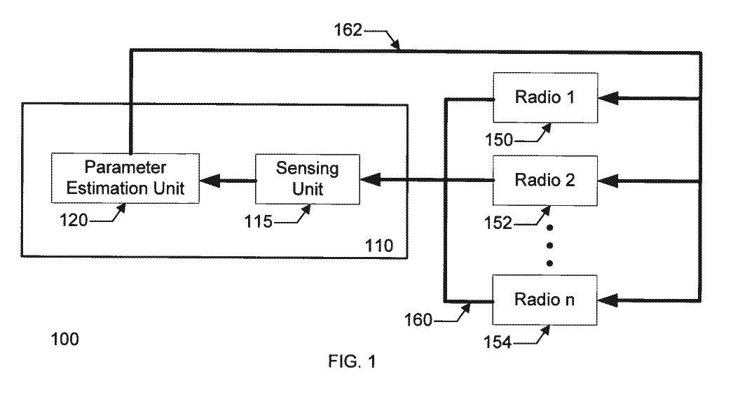

FIG. 1 shows one embodiment of a platform 100. The platform 100 has two radios 150 and 152. Radio 154 shows that there can be more than two radios in the platform 100. The platform 100 has a module 110 that connects to the radios 150,152, and 154. The module 110 contains two units, namely, the sensing unit 115 and the parameter estimation unit 120.

During operation of the platform 100, the radios 150, 152, and 154 may experience external RFI from other neighboring wireless devices. It may also experience internal RFI that is internally generated by the platform 100. For example, the RFI may come from the platform clocks and their harmonics running in the platform 100. The platform clock includes clock from, but is not limited to, Peripheral Control Interface (PCI) bus, Phase Lock Loop (PLL), Liquid Crystal Display (LCD), or any module with a clock in the platform 100 that falls in the operating band of the radios 150, 152, and 154.

The first unit in the module 110 is the sensing unit 115. The sensing unit 115 checks for RFI experienced by the radios 150, 152, and 154. In one embodiment, the sensing unit 115 is connected to the Analog to Digital Converters (ADCs) of the radios 150, 152, and 154 via communication link 160. RF signals received by the radios 150, 152, and 154 are converted to raw digital samples by the ADCs. The sensing unit 115 obtains the Inphase and Quadrature (IQ) data based on the raw digital samples from the ADCs. In other embodiments, the sensing unit 115 may obtain other data from the radios 150, 152, and 154 that can used to determine if RFI is present.

In another embodiment, the sensing unit 115 receives IQ data from the radios 150, 152, and 154 and processes the IQ data to get interference parameters. The processing of the IQ data includes, but is not limited to, radio signal processing, time domain analysis, frequency domain analysis, statistical estimation, Fourier transformation, and other methods of processing the IQ data that can give interference parameters to indicate presence of RFI. The interference parameters include, but are not limited to, processing results, statistical values or any parameters that can indicate the presence of RFI.

In one embodiment, the sensing unit 115 determines if the RFI is wideband or narrowband by performing Fourier Transformation on the IQ data. After the processing, the IQ data and the interference parameters of each radio 150, 152, and 154 are sent to the parameter estimation unit 120 in the module 110.

Compared to conventional radios that process the received IQ data directly, the sensing unit 115 has the advantage of analyzing the raw IQ data of the radios 150, 152, and 154 before any demodulation and decoding to determine if RFI exists. For conventional radios, the IQ data is processed directly and the received and decoded data does not indicate the cause of interference that degrades the performance of the radio.

The parameter estimation unit 120 receives the IQ data and interference parameters from the sensing unit 115. The parameter estimation unit 120 determines the parameters associated with a noise model from the 10 data. The noise models for RFI include, but are not limited to, Middleton's Class A, B and C statistical-physical models, Symmetric Alpha-Stable statistical models, and any other statistical or statistical-physical noise models that can model RFI. [D. Middleton, “Non-Gaussian noise models in signal processing for telecommunications: New methods and results for Class A and Class B noise models”, IEEE Transactions on Information Theory, vol. 45, no. 4, pp. 1129-1149, May 1999] Middleton's Class A noise models apply to narrowband noise where the RFI is narrower than the receiver bandwidth. Middleton's Class B noise models apply to broadband noise where the RFI is wider than the receiver bandwidth. Middleton's Class C noise models apply to a mixed case where it is a sum of Class A and Class B.

In one embodiment, the parameter estimation unit 120 applies a hypothesis test based on coherent Bayes detection to measure the deviation for zero mean due to a desired transmit signal or energy, resulting in a biased or DC value to determine if RFI exists. The Bayesian approach produces the optimal detection rule by maximizing the probability of receiving a given corrupted signal given the sent hypothesis. Bayes detection is performed by choosing the hypothesis bit that maximizes the probability of receiving a signal given the sent hypothesis. In another embodiment, the parameter estimation unit 120 uses a statistical model represented in fixed point hardware as a linear weighted sum of values or filter derived set by the output of the parameter estimation algorithm.

In one embodiment, the parameter estimation unit 120 compares the interference parameters from the sensing unit 115 with the determined parameters associated with a noise model if the comparison shows that RFI exists in any radio 150, 152, or 154, the affected radio(s) is reconfigured based on the parameters associated with the noise model from the IQ data. In another embodiment, the parameter estimation unit 120 selects the determined parameters of an affected radio that do not affect the other radios in the platform 100. The affected radio(s) is provided an input by the parameter estimation unit 120 to reconfigure itself based on the parameters via communication link 162.

In one embodiment, the reconfiguration of the radios 150, 152, or 154 includes, but is not limited to, changing the operation of transmission or reception of the radios, changing characteristics of the radios, changing modulation of the radio, changing contention windows in IEEE 802.11 radios, changing transmission parameters of the radios, or any other methods to mitigate the RFI.

In other embodiments, when the parameter estimation unit 120 determines that the RFI is due to internal RFI from the harmonics of a platform clock, the platform 100 shifts the platform clock such that the harmonics goes out of the operating band or frequency of the radios 150, 152, or 154. The parameter estimation unit 120 determines the parameters of the noise model during a radio packet interval or over multiple packet intervals with the desired dropped packet rate speed of execution. Mitigation of RFI improves communication performance such as bit error rate and extends the range of the radios 150, 152, or 154. Although the module 110 is shown as a separate block, in other embodiments, the module can be integrated into the radios 150, 152, or 154.

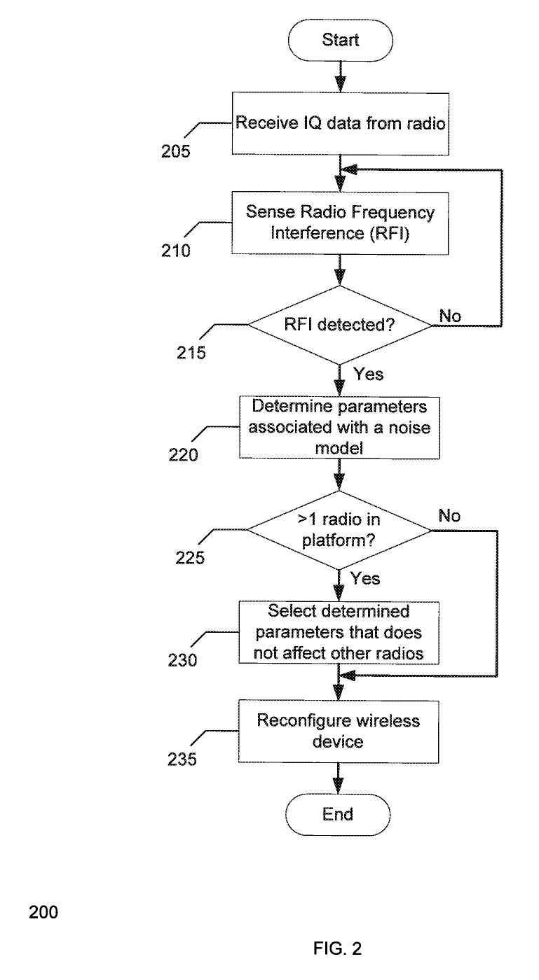

FIG. 2 illustrates a flowchart 200 of the one embodiment of the invention. The sensing unit 115 receives the IQ data from the radios 150, 152, or 154 in step 205. The sensing unit 115 senses for RFI in the IQ data by processing the IQ data in step 210. The sensing unit 115 checks if RFI is detected in step 215. If no, the sensing unit continues to sense for RFI in step 210. If yes, the parameter estimation unit 120 determines the parameters associated with a noise model from the IQ data from the sensing unit 115 in step 220. Step 225 checks if there are more than one radio in the platform 100. If yes, the parameter estimation unit 120 selects determined parameters of an affected radio that do not affect other radios in the platform 100. If no, the flow goes to step 235 to reconfigure the platform 100.

In the preceding description, various aspects of the disclosed subject matter have been described. For purposes of explanation, specific numbers, systems and configurations were set forth in order to provide a thorough understanding of the subject matter. However, it is apparent to one skilled in the relevant art having the benefit of this disclosure that the subject matter may be practiced without the specific details. In other instances, well-known features, components, or modules were omitted, simplified, combined, or split in order not to obscure the disclosed subject matter.

Various embodiments of the disclosed subject matter may be implemented in hardware, firmware, software, or combination thereof, and may be described by reference to or in conjunction with program code, such as instructions, functions, procedures, data structures, logic, application programs, design representations or formats for simulation, emulation, and fabrication of a design, which when accessed by a machine results in the machine performing tasks, defining abstract data types or low-level hardware contexts, or producing a result.

For simulations, program code may represent hardware using a hardware description language or another functional description language which essentially provides a model of how designed hardware is expected to perform. Program code may be assembly or machine language, or data that may be compiled and/or interpreted. Furthermore, it is common in the art to speak of software, in one form or another as taking an action or causing a result. Such expressions are merely a shorthand way of stating execution of program code by a processing system which causes a processor to perform an action or produce a result.

While the disclosed subject matter has been described with reference to illustrative embodiments, this description is not intended to be construed in a limiting sense. Various modifications of the illustrative embodiments, as well as other embodiments of the subject matter, which are apparent to persons skilled in the art to which the disclosed subject matter pertains are deemed to lie within the scope of the disclosed subject matter.

What is claimed is:

1. A method to mitigate non-Gaussian Radio Frequency Interference (RFI) in a platform comprising:
sensing the non Gaussian RFI in received Inphase and Quadrature (IQ) data from a radio coupled with the platform;
determining parameters associated with a noise model from the IQ data; and
reconfiguring the platform based on the parameters.

2. The method in claim 1, wherein sensing the non-Gaussian RFI comprises processing the IQ data to get interference parameters using at least one method selected from the group consisting of radio signal processing, time domain analysis, frequency domain analysis, statistical estimation and Fourier transformation, and wherein determining the parameters comprises comparing the interference parameters with the parameters associated with the noise model.

3. The method in claim 1, wherein the radio is a first radio, wherein reconfiguring the platform comprises:
selecting the determined parameters that do not affect a second radio in the platform; and
reconfiguring the first radio based on the selected determined parameters.

4. The method in claim 1, wherein sensing the non-Gaussian RFI comprises:
obtaining the IQ data based on raw samples from an Analog to Digital Converter (ADC) of the radio.

5. The method in claim 1, wherein reconfiguring the platform comprises:
changing the operation of transmission or reception of the radio based on the parameters.

6. An apparatus comprising:
a sensing unit to:
receive Inphase and Quadrature (IQ) data from a radio; and
sense non-Gaussian Radio Frequency interference (RFI) in the IQ data; and
a parameter estimation unit, communicatively coupled with the sensing unit to:
receive the IQ data from the sensing unit;
determine parameters associated with a noise model from the IQ data;
and
provide input to the radio to reconfigure itself based on the parameters.

7. The apparatus of claim 6, wherein the sensing unit to sense the non-Gaussian RFI comprises the sensing unit to process the IQ data to get interference parameters using at least one method selected from the group consisting of radio signal processing, time domain analysis, frequency domain analysis, statistical estimation and Fourier transformation, and wherein determining the parameters in the parameter estimation unit is to compare the interference parameters with the parameters associated with the noise model.

8. A wireless device comprising:
a radio to receive Radio Frequency (RF) signals;
a sensing unit, communicatively coupled with the radio to:
receive the IQ data from the radio; and
sense non-Gaussian RFI in the IQ data; and
a parameter estimation unit, communicatively coupled with the sensing unit and the radio to:
receive the IQ data from the sensing unit;
determine parameters associated with a noise model from the IQ data;
and
provide input to the radio based on the parameters,
wherein the radio is to receive the input to reconfigure itself.

9. The sensing unit in claim 8, wherein the non-Gaussian RFI is non-Gaussian RFI.

10. The wireless device of claim 8, wherein sensing the non-Gaussian RFI in the sensing unit is to process the IQ data to get interference parameters using at least one method selected from the group consisting of radio signal processing, time domain analysis, frequency domain analysis, statistical estimation and Fourier transformation, and wherein determining the parameters in the parameter estimation unit is to compare the interference parameters with the parameters associated with the noise model.

11. The parameter estimation unit in claim 8, wherein the radio is a first radio, wherein providing the input is to select the determined parameters that do not affect a second radio in the wireless device.

12. The sensing unit in claim 8, wherein sensing the non-Gaussian RFI is to obtain the IQ data based on raw samples from an Analog to Digital Converter (ADC) of the radio.

13. The radio in claim 8, wherein reconfiguring the radio is to change the operation of transmission or reception of the radio based on the input.

14. The radio in claim 8, wherein the radio operates in accordance with Bluetooth, 802.11a, 802.11b, 802.11g, 802.11n, Ultra Wide Band or Wi Max.
